(19) United States
(12) Patent Application Publication
(10) Pub. No.: US 2022/0141885 A1
(43) Pub. Date: May 5, 2022

(54) Random Access Procedure

(71) Applicant: Telefonaktiebolaget LM Ericsson (publ), Stockholm (SE)

(72) Inventors: Ritesh Shreevastav, Upplands Väsby (SE); Santhan Thangarasa, Vällingby (SE); Muhammad Kazmi, Sundbyberg (SE); Magnus Åström, Lund (SE)

(21) Appl. No.: 17/427,317

(22) PCT Filed: Jan. 30, 2020
(86) PCT No.: PCT/SE2020/050076

§ 371 Date: Jul. 30, 2021

Related U.S. Application Data
(60) Provisional application No. 62/805,482, filed on Feb. 14, 2019.

(51) Int. Cl. H04W 74/08; H04W 56/00; H04L 5/00

(52) U.S. Cl. CPC H04W 74/0841; H04L 5/0051; H04W 56/001; H04W 74/0866

(57) ABSTRACT

When a wireless device obtains a request for a random access in a cell, based on information relating to at least one type of reference signal, it selects at least one type of reference signal. The wireless device then performs a measurement in said cell using the selected type or types of reference signal. Based on a result of the measurement, the wireless device selects a coverage enhancement level, and it then sends a random access message to the cell using radio resources associated with the selected coverage enhancement level.

### TECHNICAL FIELD

This relates to a method performed by a wireless device for performing a random access.

### BACKGROUND

An area of interest in 3GPP is concerned with technologies to cover Machine-to-Machine (M2M) and/or Internet of Things (IoT) related use cases. 3GPP Release 13 and 14 include enhancements to support Machine-Type Communications (MTC) with new User Equipment (UE) categories (namely Cat-M1, Cat-M2), supporting a reduced bandwidth of 6 physical resource blocks (PRBs) (or up to 24 PRBs for Cat-M2), and Narrowband IoT (NB-IoT) UEs providing a new radio interface (and UE categories, Cat-NB1 and Cat-NB2).

We will refer herein to the LTE enhancements introduced in 3GPP Releases 13, 14 and 15 for MTC as “eMTC”, including (but not limited to) support for bandwidth limited UEs, Cat-M1, and support for coverage enhancements. This is to separate the discussion from NB-IoT (the notation here used for any Release), although the supported features are similar on a general level.

There are multiple differences between “legacy” LTE and the procedures and channels defined for eMTC and for NB-IoT. Some important differences include a new physical channel, such as the physical downlink control channels, called the MTC physical downlink control channel (MPDCCH) in eMTC and NB-IoT physical downlink control channel (NPDCCH) in NB-IoT, and a new physical random access channel, the NB-IoT physical random access channel (NPRACH), for NB-IoT.

Another important difference is the coverage level (also known as coverage enhancement level) that these technologies can support. By applying repetitions to the transmitted signals and channels, both eMTC and NB-IoT allow UE operation down to much lower Signal-to-Noise Ratio (SNR) levels compared to LTE, i.e. Es/Iot≥−15 dB defining the lowest operating point for eMTC and NB-IoT, by comparison with a threshold of −6 dB Es/IoT for “legacy” LTE.

Cell coverage in both eMTC and NB-IoT is controlled by the maximum number of repetitions of the downlink DL channels (e.g. MPDCCH, NPDCCH, the Physical Downlink Shared Channel (PDSCH) and the Narrowband PDSCH (NPDSCH), etc) used for transmitting a message. This is referred to as Rmax. Rmax may be defined in values from 1 to 2048, where the next available value is a doubling of the previous one. The coverage of a specific number of repetitions, R, is not only dependent on Rmax, but also on the message size, since a longer message typically requires a higher R compared to a shorter message, provided the same coverage. Paging messages using the xPDCCH (i.e. MPDCCH for eMTC or NPDCCH for NB-IoT) are typically the same size (though the number of repetitions of that message may not be the same) for a given cell, providing a constant maximum coverage.

Radio measurements are typically performed by the UE on the serving cell as well as on neighbour cells (e.g. NB cells, NB PRB etc) over some known reference symbols or pilot sequences, for example the Narrowband Cell-Specific Reference Signal (NB-CRS), Narrowband Secondary Synchronization Signal (NB-SSS), Narrowband Primary Synchronization Signal (NB-PSS), Resynchronization signal (RSS), etc. The measurements are done on cells on an intra-frequency carrier, and/or inter-frequency carrier(s) as well as on inter-RAT carriers(s) (depending upon the UE capability whether it supports that Radio Access technology (RAT)). To enable inter-frequency and inter-RAT measurements for the UE requiring gaps, the network has to configure the measurement gaps.

The measurements are done for various purposes. Some example measurement purposes are: mobility, positioning, self-organizing network (SON), minimization of drive tests (MDT), operation and maintenance (O&M), network planning and optimization etc. Examples of measurements in LTE are Cell identification or Physical Cell ID (PCI) acquisition, Reference Symbol Received Power (RSRP), Reference Symbol Received Quality (RSRQ), cell global ID (CGI) acquisition, Reference Signal Time Difference (RSTD), UE receive-transmit (RX-TX) time difference measurement, Radio Link Monitoring (RLM), which consists of Out of Synchronization (out of sync) detection and In Synchronization (in-sync) detection etc. Channel State Information (CSI) measurements performed by the UE are used for scheduling, link adaptation etc. by network. Examples of CSI measurements or CSI reports are Channel Quality Information (CQI), Precoder Matrix Indicator (PMI), Rank Indicator (RI) etc. They may be performed on reference signals like the Cell-Specific Reference Signal (CRS), Resynchronization signal (RSS), Narrowband Reference Signal (NRS), Channel State Information Reference Signal (CSI-RS), or DeModulation Reference Signal (DMRS).

In order to identify an unknown cell (e.g. a new neighbour cell) the UE has to acquire the timing of that cell and eventually the physical cell ID (PCI). In legacy LTE operation the DL subframe #0 and subframe #5 carry synchronization signals (i.e. both the Primary Synchronization Signal (PSS) and Secondary Synchronization Signal (SSS)). The synchronization signals used for NB-IOT are known as NB-PSS and NB-SSS and their periodicity may be different from the LTE legacy synchronization signals. This is called cell search or cell identification. Subsequently the UE also measures RSRP and/or RSRQ of the newly identified cell in order to use the measurement itself and/or report the measurement to the network node. In total there are 504 PCIs in NB-IoT RAT. The cell search is also a type of measurement. The measurements are done in all Radio Resource Control (RRC) states i.e. in RRC idle and connected states. In RRC connected state the measurements are used by the UE for one or more tasks such as for reporting the results to the network node. In RRC idle the measurements are used by the UE for one or more tasks such as for cell selection, cell reselection etc.

Random access is a fundamental procedure that is supported in most cellular systems, e.g. LTE, MTC, NB-IoT. The random access procedure is used for one or more purposes e.g. initial access (for UEs in the RRC_IDLE state), accessing resources for initiating UE or network originated call, resynchronization of the uplink (UL), scheduling request, positioning, RRC re-establishment for example after radio link failure etc.

The first step in random access procedure is the transmission of a preamble, which is transmitted on a physical random access channel (PRACH), such as NPRACH for NB-IoT. The resources available for PRACH transmission is typically provided to the UE in the system information blocks, e.g. in SIB2-NB or in a dedicated channel via RRC. The resources consist of preamble sequences, one or more time/frequency resources, a number of repetitions per NPRACH preamble transmission etc.

The UE can also perform both contention based and non-contention based random access. A non-contention based random access or contention free random access can be initiated by the network node e.g. the eNodeB. The eNodeB initiates a non-contention based random access either by sending a message in a DL control channel such as NPDCCH or by indicating it in an RRC message. The eNodeB can also order the UE to perform a contention based random access.

In legacy systems, CRS based Radio Resource Management (RRM) measurements are used in cell change procedures. Examples of cell change procedures are cell reselection, handover, RRC re-establishment, RRC connection release with redirection, etc. The UE sends random access (RA) in the target cell during a cell change procedure in order to access the target cell. The selection of some of the RA parameters is based on path loss estimation, which in turn is derived from signal strength measurement on the target cell e.g. RSRP. The measurement accuracy of CRS based RSRP/RSRQ measurement can be quite poor, especially under enhanced coverage. But, even under normal coverage operation, the absolute RSRP measurement accuracy is defined as ±7 dB (i.e. measured RSRP to be accurate within ±7 dB), which is quite coarse. Using such measurements for the random access procedure can lead to inaccurate decisions, which can result in increased network/UE resources.

Certain aspects of the present disclosure and their embodiments may provide solutions to these or other challenges.

### SUMMARY

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

According to a first aspect, there is provided a method performed by a wireless device for accessing a cell of a network. The method comprises, in response to a request for a random access in said cell, and based on information relating to at least one type of reference signal, selecting at least one type of reference signal. The wireless device then performs a measurement in said cell using the selected at least one type of reference signal; and, based on a result of the measurement, it selects a coverage enhancement level. The wireless device then sends a random access message to said cell using radio resources associated with the selected coverage enhancement level.

The method may comprise generating the request for a random access within the wireless device, or may comprise receiving the request for a random access from a node of the network.

The method may comprise receiving the information relating to at least one type of reference signal from a RRC System Information Broadcast message.

The method may comprise receiving the information relating to at least one type of reference signal in dedicated RRC signalling.

The step of selecting at least one type of reference signal may comprise selecting at least one type of reference signal from at least two types of reference signal.

The method may comprise selecting at least one type of reference signal based on a number of coverage enhancement levels configured in said cell.

The method may comprise selecting a first type of reference signal if the number of coverage enhancement levels configured in said cell does not exceed a threshold number; and selecting a second type of reference signal if the number of coverage enhancement levels configured in said cell exceeds said threshold number.

The method may comprise selecting a first type of reference signal if the number of coverage enhancement levels configured in said cell does not exceed a threshold number; and selecting the first type of reference signal and a second type of reference signal if the number of coverage enhancement levels configured in said cell exceeds said threshold number.

The method may comprise selecting either a first type of reference signal or a second type of reference signal if the number of coverage enhancement levels configured in said cell does not exceed a threshold number; and selecting the second type of reference signal if the number of coverage enhancement levels configured in said cell exceeds said threshold number.

The first type of reference signal may comprise fewer resource elements than the second type of reference signal over a given bandwidth.

The first type of reference signal may comprise fewer resource elements per resource block than the second type of reference signal.

The first and second types of reference signal may have different periodicities.

The first type of reference signal may be the Cell-Specific Reference Signal, CRS, or may be the Narrowband Reference Signal, NRS.

The second type of reference signal may be the Resynchronization signal, RSS, or may be the Secondary Synchronization Signal, SSS, or may be the Narrowband Secondary Synchronization Signal, NSSS.

The second type of reference signal may provide better measurement accuracy than the first type of reference signal.

The threshold number may be a predefined number.

The method may comprise receiving information from the network determining the threshold number.

The method may comprise determining the threshold number based on information stored in the wireless device.

The method may comprise determining the threshold number based on stored information relating to previous usage of the wireless device.

The method may comprise selecting at least one type of reference signal based on information signaled to the wireless device from the network. In that case, the second type of reference signal may be the Resynchronization signal, RSS.

The method may comprise selecting at least one type of reference signal based on a procedure requiring said random access.

The method may comprise selecting a first type of reference signal for at least a first procedure; and selecting a second type of reference signal for at least a second procedure.

The method may comprise selecting a first type of reference signal for an initial access procedure requiring said random access; and selecting a second type of reference signal for a cell change procedure requiring said random access.

The first type of reference signal may comprise fewer resource elements than the second type of reference signal over a given bandwidth.

The first type of reference signal may comprise fewer resource elements per resource block than the second type of reference signal.

The first and second types of reference signal may have different periodicities.

The first type of reference signal may be the Cell-Specific Reference Signal, CRS, or may be the Narrowband Reference Signal, NRS.

The second type of reference signal may be the Resynchronization signal, RSS, or may be the Secondary Synchronization Signal, SSS, or may be the Narrowband Secondary Synchronization Signal, NSSS.

The second type of reference signal may provide better measurement accuracy than the first type of reference signal.

The measurement may comprise a path loss measurement, or the measurement may comprise a signal strength measurement.

The method may comprise selecting the coverage enhancement level based on a result of comparing the result of the measurement with at least one threshold value.

The radio resources may be are associated with the selected coverage enhancement level based on one or more of:

a pre-defined relation or mapping,

information received from another node e.g. information signaled by the network node to the wireless device,

historical data or statistics, and

recently used radio resources for the selected coverage enhancement level.

The radio resources may comprise:

a pre-amble identifier, e.g. RA sequence,

a number of repetitions per RA attempt (Rp),

a maximum number of RA attempts (Rr), and

at least one transmit power level(s) for sending the RA to said cell.

The method may further comprise notifying the network of the selected type of reference signal.

The method may further comprise notifying the network of statistics related to usage of at least one type of reference signal.

The method may further comprise notifying the network of at least one type of procedure for which the selected type of reference signal was used.

The method may comprise notifying the network using Layer 1 channels, for example the Physical Uplink Control Channel, PUCCH, or may comprise notifying the network using Medium Access Control, MAC, or may comprise notifying the network using Radio Resource Control, RRC.

The method may further comprise providing user data; and forwarding the user data to a host computer via the transmission to the base station.

According to a second aspect, there is provided a method performed by a network node for configuring a wireless device for performing a random access in a cell. The method comprises causing information to be transmitted to a wireless device, said information identifying at least one type of reference signal, to be selected by the wireless device for performing said random access.

The method may comprise causing information to be transmitted to the wireless device, said information identifying at least one type of reference signal, to be selected by the wireless device for performing a measurement, wherein the wireless device will use a result of the measurement to select resources to be used for said random access.

The method may comprise receiving information included in a random access message from the wireless device.

The method may comprise selecting the at least one type of reference signal to be identified to the wireless device, based on respective performances of a plurality of types of reference signal, from which the at least one type of reference signal is selected.

The method may comprise selecting the at least one type of reference signal to be identified to the wireless device, based on respective transmission powers of a plurality of types of reference signal, from which the at least one type of reference signal is selected.

The method may comprise selecting the at least one type of reference signal to be identified to the wireless device, based on a duration of at least one of a plurality of types of reference signal, from which the at least one type of reference signal is selected.

The method may comprise selecting the at least one type of reference signal to be identified to the wireless device, based on a number of coverage enhancement levels configured or expected to be configured for enabling the wireless device to access said cell.

The method may comprise selecting the at least one type of reference signal to be identified to the wireless device, based on a procedure for which the wireless device requires to access said cell.

The method may comprise selecting a first type of reference signal to be identified to the wireless device for an initial random access, and selecting a second type of reference signal to be identified to the wireless device for a cell change procedure.

The first type of reference signal may comprise fewer resource elements than the second type of reference signal over a given bandwidth.

The first type of reference signal may comprise fewer resource elements per resource block than the second type of reference signal.

The first and second types of reference signal may have different periodicities.

The first type of reference signal may be the Cell-Specific Reference Signal, CRS, or may be the Narrowband Reference Signal, NRS.

The second type of reference signal may be the Resynchronization signal, RSS, or may be the Secondary Synchronization Signal, SSS, or may be the Narrowband Secondary Synchronization Signal, NSSS.

The second type of reference signal may provide better measurement accuracy than the first type of reference signal.

The method may comprise selecting the at least one type of reference signal to be identified to the wireless device, based on properties of the wireless device.

The method may comprising selecting the at least one type of reference signal to be identified to the wireless device, based on a battery status of the wireless device.

The method may comprise receiving information from the wireless device about a selected type of reference signal.

The method may further comprise using said received information for one or more of: modifying or adapting a number of coverage enhancement levels to be configured in said cell, adapting receiver parameters of the base station for receiving signals from the wireless device, configuring the wireless device with a particular type of reference signal to be used by the wireless device for accessing said cell.

The method may further comprise obtaining user data; and forwarding the user data to a host computer or a wireless device.

According to a further aspect, there is provided a wireless device, the wireless device comprising: processing circuitry configured to perform any of the steps of any method according to the first aspect; and power supply circuitry configured to supply power to the wireless device.

According to a further aspect, there is provided a base station, the base station comprising: processing circuitry configured to perform any of the steps of any method according to the second aspect; and power supply circuitry configured to supply power to the base station.

According to a further aspect there is provided a user equipment, UE, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the methods according to the first aspect;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

According to a further aspect, there is provided a communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the methods according to the second aspect.

The communication system may further include the base station.

The communication system may further include the UE, wherein the UE is configured to communicate with the base station.

In the communication system,
the processing circuitry of the host computer may be configured to execute a host application, thereby providing the user data; and
the UE may comprise processing circuitry configured to execute a client application associated with the host application.

According to a further aspect, there is provided a method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the methods according to the second aspect.

The method may further comprise, at the base station, transmitting the user data.

The user data may be provided at the host computer by executing a host application, the method further comprising, at the UE, executing a client application associated with the host application.

According to a further aspect, there is provided a user equipment, UE, configured to communicate with a base station, the UE comprising a radio interface and processing circuitry configured to perform the methods of the previous aspect.

According to a further aspect, there is provided a communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the methods according to the first aspect.

The cellular network may further include a base station configured to communicate with the UE.

In the communication system:
the processing circuitry of the host computer may be configured to execute a host application, thereby providing the user data; and
the UE's processing circuitry is configured to execute a client application associated with the host application.

According to a further aspect, there is provided a method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any method according to the first aspect.

The method may further comprise, at the UE, receiving the user data from the base station.

According to a further aspect, there is provided a communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any method according to the first aspect.

The communication system may further include the UE.

The communication system may further include the base station, wherein the base station comprises a radio interface configured to communicate with the UE and a communication interface configured to forward to the host computer the user data carried by a transmission from the UE to the base station.

In the communication system:
the processing circuitry of the host computer may be configured to execute a host application; and
the UE's processing circuitry may be configured to execute a client application associated with the host application, thereby providing the user data.

In the communication system:
the processing circuitry of the host computer may be configured to execute a host application, thereby providing request data; and
the UE's processing circuitry may be configured to execute a client application associated with the host application, thereby providing the user data in response to the request data.

According to a further aspect, there is provided a method implemented in a communication system including a host computer, a base station and a user equipment (UE), the method comprising:
at the host computer, receiving user data transmitted to the base station from the UE, wherein the UE performs any of the steps of any method according to the first aspect.

The method may further comprise, at the UE, providing the user data to the base station.

The method may further comprise:
at the UE, executing a client application, thereby providing the user data to be transmitted; and
at the host computer, executing a host application associated with the client application.

The method may further comprise:
at the UE, executing a client application; and
at the UE, receiving input data to the client application, the input data being provided at the host computer by executing a host application associated with the client application,
wherein the user data to be transmitted is provided by the client application in response to the input data.

According to a further aspect, there is provided a communication system including a host computer comprising a communication interface configured to receive user data originating from a transmission from a user equipment (UE) to a base station, wherein the base station comprises a radio interface and processing circuitry, the base station's processing circuitry configured to perform any of the steps of any method according to the second aspect.

The communication system of the previous embodiment may further include the base station.

The communication system may further include the UE, wherein the UE is configured to communicate with the base station.

In the communication system:
the processing circuitry of the host computer may be configured to execute a host application;
the UE may be configured to execute a client application associated with the host application, thereby providing the user data to be received by the host computer.

According to a further aspect, there is provided a method implemented in a communication system including a host computer, a base station and a user equipment (UE), the method comprising:
at the host computer, receiving, from the base station, user data originating from a transmission which the base station has received from the UE, wherein the UE performs any of the steps of any method according to the first aspect.

The method may further comprise, at the base station, receiving the user data from the UE.

The method may further comprise, at the base station, initiating a transmission of the received user data to the host computer.

Thus, the invention comprises several embodiments for a wireless device (e.g. UE) and network node (e.g. eNodeB).

In certain embodiments, a UE obtains a request to transmit a random access message (M1) to a first cell (cell1), and information related to at least one out of plurality of reference signals type (RS1, RS2, etc.) based on at least a number of CE levels configured in cent and uses the obtained RS type for performing a measurement (e.g. RSRP, NRSRP etc). The measurement is used by the UE for selecting a CE level of the UE with respect to cent which in turn is used for determining the radio resources (R1) associated with the determined CE level and transmits the message M1 using R1 to cell1.

In other embodiments, a network node determines at least one type of RS to be used by the UE for accessing a first cell (cell1) based on at least a number of CE levels configured in cent and transmits information about the determined RS type(s) to the UE. The NW may further receive a random access (RA) message from the UE in cent wherein the RA is transmitted by the UE based on a measurement which is based on the type of the RS determined by NW and whose information is signalled to the UE.

Certain embodiments may provide one or more technical advantages.

The method may enable the network to control UE random access performance e.g. by appropriate selection of RS type based on the coverage levels used in a cell.

A UE can make a more reliable CE level selection when accessing a new cell and this has many advantages for both network node and UE. For network node, use of radio resources can be improved as a more correct CE level selection means the network does not have to transmit with more resources than necessary. For the UE, for example fewer repetitions can be used in the receptions and/or transmissions of signals and this can improve the battery life.

### BRIEF DESCRIPTION OF THE DRAWINGS

Reference will now be made, by way of example, to the accompanying drawings, in which:

FIG. 1 illustrates a part of a cellular communications network, in which the methods disclosed herein may be implemented.

FIG. 2 is a flow chart showing a method performed by a wireless device for accessing a cell of a network.

FIG. 3 illustrates a first example of the selection of a coverage enhancement level.

FIG. 4 illustrates a second example of the selection of a coverage enhancement level.

FIG. 5 is a flow chart showing a method performed by a network node for allowing a wireless device to access a cell of a network.

FIG. 6 shows a wireless network in accordance with some embodiments.

FIG. 7 shows a User Equipment in accordance with some embodiments.

FIG. 8 shows a virtualization environment in accordance with some embodiments.

FIG. 9 shows the connection of a telecommunication network via an intermediate network to a host computer in accordance with some embodiments.

FIG. 10 shows a host computer communicating via a base station with a user equipment over a partially wireless connection in accordance with some embodiments.

FIG. 11 shows methods implemented in a communication system including a host computer, a base station and a user equipment in accordance with some embodiments.

FIG. 12 shows methods implemented in a communication system including a host computer, a base station and a user equipment in accordance with some embodiments.

FIG. 13 shows methods implemented in a communication system including a host computer, a base station and a user equipment in accordance with some embodiments.

FIG. 14 shows methods implemented in a communication system including a host computer, a base station and a user equipment in accordance with some embodiments.

FIG. 15 illustrates a virtualization apparatus in accordance with some embodiments.

FIG. 16 illustrates a virtualization apparatus in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

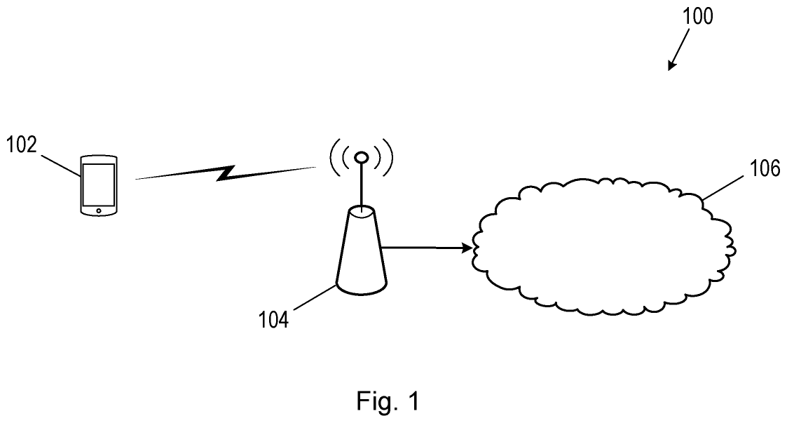

FIG. 1 illustrates a part of a cellular communications network 100, in which the methods disclosed herein may be implemented.

Specifically, FIG. 1 shows a wireless device 102, having a wireless connection to a base station 104 of the radio access network in the cellular communications network 100. The cellular communications network 100 also includes a core network 106.

In the following description, the general term “network node” is used and it can correspond to any type of radio network node or any network node, which communicates with a UE and/or with another network node. Examples of network nodes are a NodeB, a Master eNodeB (MeNB), a Secondary eNodeB (SeNB), a network node belonging to a Master Cell Group (MCG) or a Secondary Cell Group (SCG), a base station (BS), a multi-standard radio (MSR) radio node such as MSR BS, an eNodeB, a gNodeB, a network controller, a radio network controller (RNC), a base station controller (BSC), a relay, a donor node controlling relay, a base transceiver station (BTS), an access point (AP), transmission points, transmission nodes, a remote radio unit (RRU), a remote radio head (RRH), nodes in a distributed antenna system (DAS), core network nodes (such as a mobile switching centre (MSC), Mobility Management Entity MME, etc), an operations and maintenance (O&M) node, an operations support system (OSS) node, a self-organising network (SON) node, a positioning node (for example a Serving Mobile Location Centre (SMLC) or an E-SMLC), a minimizing drive test (MDT) node, test equipment (physical node or software), etc.

In some embodiments the non-limiting term user equipment (UE) or wireless device is used, and it refers to any type of wireless device communicating with a network node and/or with another UE in a cellular or mobile communication system. Examples of UEs are a target device, a device to device (D2D) UE, a machine type UE or UE capable of machine to machine (M2M) communication, a personal digital assistant (PDA), a Tablet, a mobile terminal, a smart phone, laptop embedded equipment (LEE), laptop mounted equipment (LME), USB dongles, ProSe UE, a vehicle-to-vehicle (V2V) UE, a vehicle-to-anything (V2X) UE, etc.

The embodiments are described for the Long Term Evolution (LTE) network e.g. Machine-Type Communications (MTC) and Narrowband IoT (NB-IoT). However, the embodiments are applicable to any Radio Access Technology (RAT) or multi-RAT systems, where the UE receives and/or transmit signals (e.g. data) e.g. LTE frequency division duplex (FDD) and/or time division duplex (TDD), wideband code division multiple access (WCDMA) or high speed packet access (HSPA), the Global System for Mobile Communications (GSM) or GSM Edge Radio Access Network (GERAN), Wi Fi, Wireless Local Area Network (WLAN), CDMA2000, 5G, New Radio (NR), etc.

The term “time resource” used herein may correspond to any type of physical resource or radio resource expressed in terms of length of time. Examples of time resources are: a symbol, a mini-slot, a time slot, a subframe, a radio frame, a Transmission Time Interval (TTI), a short TTI, an interleaving time, etc.

The following description relates generally to a scenario in which a UE is served by a first cell (cell1). Celli is managed or served or operated by a network node (NW1) e.g. a base station. The UE operates in a certain coverage enhancement (CE) level with respect to a certain cell, for example with respect to cell1. The UE is configured to receive signals (e.g. paging signals, a wake-up signal (WUS), the MTC physical downlink control channel (MPDCCH), the NB-IoT physical downlink control channel (NPDCCH), the MTC physical downlink shared channel (MPDSCH), the NB-IoT physical downlink shared channel (NPDSCH), etc) from at least cell1.

The UE may further be configured for performing one or more measurement on cell1 and on one or more additional cells e.g. neighbour cells.

The coverage enhancement (CE) level of the UE is also interchangeably called the coverage level of the UE. The CE level can be expressed in terms of:
received signal quality and/or received signal strength at the UE with respect to a cell and/or
received signal quality and/or received signal strength at a cell with respect to the UE.

The CE level of the UE may be defined with respect to any cell such as a serving cell, a neighbour cell, a reference cell etc. For example, it can be expressed in terms of a received signal quality and/or a received signal strength at the UE with respect to a target cell on which the UE performs one or more radio measurements.

Examples of signal quality are Signal-to-Noise Ratio (SNR), Signal-to-Interference-and-Noise Ratio (SINR), Channel Quality Indicator (CQI), Reference Symbol Received Quality (RSRQ), Narrowband RSRQ (NRSRQ), Cell-Specific Reference Signal (CRS) Ês/Iot, Shared Channel (SCH) Ês/Iot etc. Examples of signal strength are path loss, couple loss, Reference Symbol Received Power (RSRP), Narrowband RSRP (NRSRP), Shared Channel Received Power (SCH_RP), etc.

The notation Ês/Iot is defined as the ratio of:
Ês, which is the received energy per Resource Element (RE) (with the power normalized to the subcarrier spacing) during the useful part of the symbol, i.e. excluding the cyclic prefix, at the UE antenna connector, to
Iot which is the received power spectral density of the total noise and interference for a certain RE (with the power integrated over the RE and normalized to the subcarrier spacing) as measured at the UE antenna connector.

The CE level can be expressed in at least two different levels. Consider an example of two different CE levels defined with respect to signal quality (e.g. SNR) at the UE comprising of:
Coverage enhancement level 1 (CE1) comprising of SNR≥−6 dB at UE with respect to a cell; and

Coverage enhancement level 2 (CE2) comprising of −15 dB≤SNR<−6 dB at UE with respect to a cell.

In the above example, the CE1 may also be interchangeably called the normal coverage level (NCL), the baseline coverage level, the reference coverage level, the basic coverage level, the legacy coverage level etc. On the other hand, CE2 may be termed as the enhanced coverage level or extended coverage level (ECL).

In another example, two different coverage levels (e.g. normal coverage and enhanced coverage) may be defined in terms of signal quality levels as follows:
The requirements for normal coverage are applicable for the UE category NB1 with respect to a cell, provided that radio conditions of the UE with respect to that cell are defined as follows SCH Ês/Iot≥−6 dB and CRS Ês/Iot≤−6 dB.
The requirements for enhanced coverage are applicable for the UE category NB1 with respect to a cell, provided that radio conditions of the UE with respect to that cell are defined as follows SCH Ês/Iot≥−15 dB and CRS Ês/Iot≤−15 dB.

In another example, one or more parameters defining CE of the UE with respect to a cell (e.g. serving cell, neighbour cell etc) may also be signalled to the UE by the network node. Examples of such parameters are CE Mode A and CE Mode B signalled to UE category M1, UE category M2 etc. The UE configured with CE Mode A and CE Mode B are also said to operate in normal coverage and enhanced coverage respectively. For example:
The requirements for CE Mode A apply provided the UE category M1 or UE category M2 is configured with CE Mode A, SCH Ês/Iot≥−6 dB and CRS Ês/Iot≥−6 dB.
The requirements for CE Mode B shall apply provided the UE category M1 or UE category M2 is configured with CE Mode B, SCH Ês/Iot≥−15 dB and CRS Ês/Iot≥−15 dB.

In another example the UE may also determine the CE level with respect to a cell (e.g. cell1 etc) during the random access transmission procedure to that cell. For example, the UE selects the random access transmission resources (e.g. repetition level of RA channels) which are associated with different CE levels (e.g. PRACH CE level 0, CE level 1, CE level 2, CE level 3 etc) based on the received signal level (e.g. RSRP, NRSRP etc). The UE selects or determines the CE level (e.g. PRACH CE level) based on the signal measurement results performed by the UE (e.g. RSRP, NRSRP, path loss).

In general, at a larger CE level, the UE is capable of operating under a received signal level (e.g. RSRP, path loss, SNR, SINR, Ês/Iot, RSRQ etc) which is lower than the received signal level in a smaller CE level. The embodiments described below are applicable for any number of CE levels of the UE with respect to a cell e.g. CE1, CE2, CE3, CE4 etc. In this example CE1 corresponds to the smallest CE level, while CE2 corresponds to a larger CE level with respect to CE1 but smaller with respect to CE3 and CE3 corresponds to larger CE level with respect to CE2 but smaller with respect to CE4 and so on.

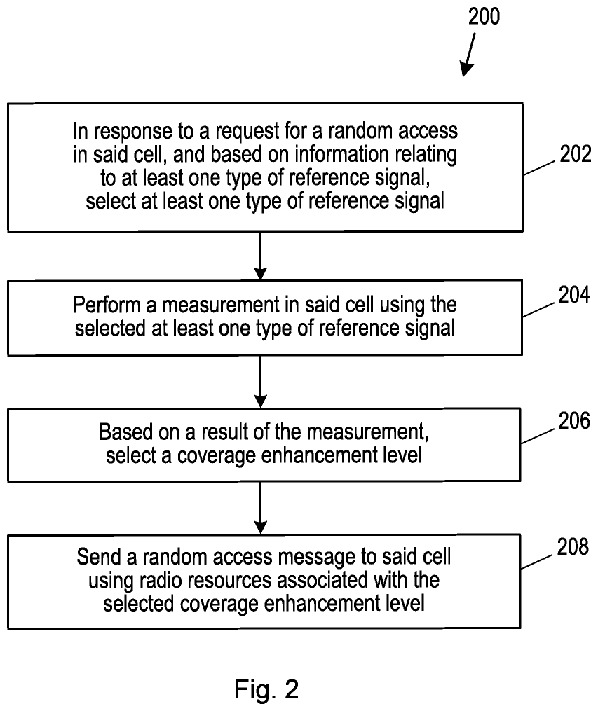

FIG. 2 is a flow chart, illustrating an example of a method 200 performed in a wireless device. Specifically, FIG. 2 depicts a method performed by a wireless device in accordance with particular embodiments for accessing a cell of a network.

The method begins when the wireless device obtains or receives a request to transmit at least one random access (RA) message to a first cell, cell1.

In this embodiment, the UE obtains a request from its higher layers to transmit one random access message (M1) to a first cell (cell1). Celli may be a serving cell or it may be a target cell during a cell change procedure. Examples of cell change procedures are cell reselection, handover, Radio Resource Control (RRC) re-establishment, RRC connection release with redirection, etc. The UE may have to send the RA message to the serving cell (without a cell change) e.g. for enabling the base station to acquire a new timing advance parameter, for positioning measurements, arrival of data in the UE buffer etc.

The random access (RA) message, M1, can be contention based or it can be non-contention based, and typically consists of a preamble sequence. The preamble sequence may be autonomously and randomly selected by the UE, e.g. for contention based RA transmission. The preamble sequence may also be assigned or configured by the network node to the UE e.g. for non-contention based RA transmission. The message may further contain, or be encoded with, additional information e.g. UE identifier etc.

In one example, the request for sending the random access (RA) message is generated internally by the UE, i.e. by the higher layers without receiving any external request from another node. For example, in this case the UE may decide to send the RA message when one or more condition is triggered, for example receiving a paging message, needing to acquire a timing advance command, data arriving in the UE buffer, the UE initiating a call, etc.

In another example, the request for sending the random access (RA) message is generated by the higher layers, which in turn may have received the request from another node, e.g. from a network node such as the serving network node. In the latter case, the network node may also provide additional information to the UE for sending the RA message. Examples of additional information are a preamble (also known as a RA sequence) to be used by the UE for sending the RA message, identifier(s) of the carrier to which the RA message is to be sent i.e. ID of cent radio resources to be used by the UE for sending the RA message, etc. Examples of an ID of the carrier are a frequency channel number, such as the Absolute Radio Frequency Channel Number (ARFCN), or E-UTRA ARFCN (EARFCN) etc.

The wireless device then obtains information related to at least one reference signal type (referred to below as RS1 and RS2), based on at least a number of CE levels configured in cell1 for accessing cell1,

In some embodiments, the UE obtains information related to two types of reference signal (RS), and selects at least one type to be used for accessing cell1. The UE may obtain such information from a RRC System Information Broadcast message or may alternatively or additionally obtain it from dedicated RRC signalling. The type of RS to be used by the UE for accessing cell1 is associated with at least information about coverage enhancement (CE) levels configured in cell1. The configured CE levels in cell1 are used by the UE for selecting one or more parameters associated with the RA transmission in cell1.

The information obtained in this step indicates which RS type to use for conducting the measurement and using it for random access in cell1. When the number of CE levels increases, a measurement with high accuracy is desired to make the correct decision, and so the RS type is adapted based on the number of CE levels configured in cent as described below.

In some embodiments, the UE obtains information about a CE threshold (N_{G}) in terms of the number of CE levels, for deciding the type of RS to be used for accessing cell1, e.g. for sending the RA message to cell1. The UE also obtains information about the number of CE levels (NCO configured in cell1 for accessing cell1. The UE selects the type of RS (e.g. RS1 or RS2) for accessing cell1 based on a relation or association or mapping between the parameters N_{G} and N_{CE}. The relation or association may enable the UE to use either one of the RS types or two or more RS types or any one of the possible RS types. This is explained with various examples below.

An example of RS1 is a Cell-Specific Reference Signal (CRS) and an example of RS2 is a Resynchronization signal (RSS), for example as described in 3GPP TS 36.211 v15.4.0, section 6.11.3. An alternative example of RS2 is a Secondary Synchronization Signal (SSS). Another example of RS1 is a Narrowband Reference Signal (NRS) and another example of RS2 that may be used with the NRS as RS1 or separately is a Narrowband Secondary Synchronization Signal (NSSS). The difference between RS1 and RS2 may be that the former comprises fewer resource elements (REs) compared to the number of resource elements comprised in RS2 over the same bandwidth e.g. the number of REs per resource block (RB). For example CRS, which is an example of RS1, is transmitted by the BS in every 6th resource element in a RB. On the other hand, as an example, RSS, which is an example of RS2, is transmitted by the BS in every resource element over a certain number of symbols within a RB.

Another difference could be in terms their periodicities, i.e. how frequency are available for measurements.

In one example:
If N_{CE}≤N_{G}, then the UE uses a first type of RS (RS1) for accessing cell1 and
Otherwise (i.e. if N_{CE}>N_{G}) the UE uses a second type of RS (RS2) for accessing cell1.

N_{CE} can be enumerated as 1, 2, 3, 4 and so on. Each number corresponds to respective CE levels (e.g. CE level 0, CE level 1 etc). This is shown in an example in table 1 for N_{CE}=4. A larger value of the CE level (e.g. CE level 3) corresponds to more extended coverage compared to a smaller value of the CE level (e.g. CE level 2).

TABLE 1
Example of parameter N_{G} comprising two possible values

| Number of | | |
|---|---|---|
| configured | Corresponding | Relation between |
| CE levels (N_{CE}) | CE levels | configured CE levels |
| 1 | CE level 0 | N/A |
| 2 | CE level 0, CE level 1 | CE level 1 > CE level 0 |
| 3 | CE level 0, CE level 1, | CE level 2 > CE level 1 > |
| | CE level 2 | CE level 0> |
| 4 | CE level 0, CE level 1, | CE level 3 > CE level 2 > |
| | CE level 2, CE level 3 | CE level 1 > CE level 0> |

The parameter N_{G} can be obtained by the UE by any of the following means:
Pre-defined rule e.g. N_{G} is predefined such as N_{G}=1.
Information obtained from a network node e.g. from the serving cell, which during a cell change procedure can also be the old serving cell.
Autonomously by the UE e.g. based on statistics such as history or previously used parameter.

In one example if the UE does not obtain the parameter N_{G}=1, (e.g. not signalled to the UE) then the UE assumes that RS1 should be used for accessing cell1. In another example, the UE uses a default value if it is defined and selects the type of RS based on the default value for accessing cell1.

In one example the parameter N_{G} may comprise only one numerical value. In another example the parameter N_{G} may comprise multiple numerical values. This is explained with several examples:
One specific example is shown in table 2. If the UE is configured with configuration #0 then the UE determines that N_{G}=1 for accessing cell1. In this case (configuration #0) the UE uses RS2 only if the number of configured CE levels in cell1 (N_{CE}) is larger than one. If the UE is configured with configuration #1 then the UE determines that N_{G}=2 for accessing cell1. In this case (configuration #1) the UE uses RS2 only if the number of configured CE levels in cell1 (N_{CE}) is larger than two. The use of RS2 will enable the UE to estimate the signal level with respect to cell1 (e.g. path loss) for RA more accurately and therefore enhances the RA performance when the number of CE levels configured in cell1 is larger.

TABLE 2
Example of parameter N_{G} comprising two possible
values for using one of RS1 and RS2

| Configuration ID | N_{G} | Selection of RS type |
|---|---|---|
| 0 | 1 | use RS2 if N_{CE} > 1; otherwise use RS1 for RA |
| 1 | 2 | use RS2 if N_{CE} > 2; otherwise use RS1 for RA |

Yet another example is shown in table 3. In this case N_{G} has three possible values (1, 2 and 3). One of the three configurations can be signalled to the UE for enabling the UE to select one of the pluralities of RS types for accessing cell1.

TABLE 3
Example of parameter N_{G} comprising three possible
values for using one of RS1 and RS2

| Configuration ID | N_{G} | Selection of RS type |
|---|---|---|
| 0 | 1 | use RS2 if N_{CE} > 1; otherwise use RS1 for RA |
| 1 | 2 | use RS2 if N_{CE} > 2; otherwise use RS1 for RA |
| 2 | 3 | use RS2 if N_{CE} > 3; otherwise use RS1 for RA |

Yet another example is shown in table 4. If N_{CE}>N_{G} then the UE is required to use both RS1 and RS2 for accessing the cell. Otherwise the UE is required to use only RS1 for accessing cell1.

TABLE 4
Example of parameter N_{G} comprising two possible
values for using both RS1 and RS2

| Configuration ID | N_{G} | Selection of RS type |
|---|---|---|
| 0 | 1 | use RS1 and RS2 if N_{CE} > 1; otherwise use |
| | | RS1 for RA |
| 1 | 2 | use RS1 and RS2 if N_{CE} > 2; otherwise use |
| | | RS1 for RA |

Yet another example is shown in table 5. If N_{CE}>N_{G} then the UE is required to use RS2 for accessing the cell. Otherwise the UE is allowed to use any of RS1 and RS2 for accessing cell1.

TABLE 5
Example of parameter N_{G} comprising two possible values
for using any of RS1 and RS2 based on signaled value

| Configuration ID | N_{G} | Selection of RS type |
|---|---|---|
| 0 | 1 | use RS2 if N_{CE} > 1; otherwise use any of |
| | | RS1 and RS2 for RA |
| 1 | 2 | use RS2 if N_{CE} > 2; otherwise use any of |
| | | RS1 and RS2 for RA |

In some other embodiments, the UE directly obtains information about the type of the RS to be used for accessing cell1. This is explained with several examples below:
One example is shown in table 6. In this example the UE is configured to use either RS type 1 (RS1) or RS type 2 (RS2) for accessing cell1. The information is signalled to the UE by the network node. For example, the network node may select the value of the parameter based on a number of CE levels configured in cell1 for accessing cell1. As an example, if the number of CE levels configured in cell1 is small (e.g. 2 or 1) then the network node may configure the UE with RS1 for accessing cell1. But if the number of CE levels configured in cell1 is larger (e.g. more than 2) then the network node configures the UE with RS2 for accessing cell1.

TABLE 6
Example of a 1-bit indicator used to signal the reference signal type
to be used by the UE for CE level selection during random access

| Configuration ID | Meaning | Field description |
|---|---|---|
| 0 | Use RS TYPE#1 | CE level selection for random |
| | | access shall be based on RS |
| | | Type#1 based measurement. |
| 1 | Use RS TYPE#2 | CE level selection for random |
| | | access shall be based on RS |
| | | Type#2 based measurement. |

In terms of signalling, the above table 6 can be translated as the following example to be used in RRC Signaling.

rs-type-r16ENUMERATED {rs1, rs2}

A further combination of rs1-rs2 can also be signaled.

rs-type-r16 ENUMERATED {rs1, rs2, rs1and2}
Another example is shown in table 7. In this example the UE is configured with 4 possible cases related to the use of RS1 and RS. For example the UE can be configured with any of these 4 possible configurations:
Configuration #0: use RS type 1 (RS1) for accessing cell1,
Configuration #1: use RS type 2 (RS2) for accessing cell1,
Configuration #2: use any of RS1 and RS2 for accessing cell1,
Configuration #3: use both RS1 and RS2 for accessing cell1,

TABLE 7
Example of a 2-bit indicator used to signal the reference signal type
to be used by the UE for CE level selection during random access

| Configuration ID | Meaning | Field description |
|---|---|---|
| 0 | Use RS TYPE#1 | CE level selection for random |
| | | access shall be based on RS |
| | | Type#1 based measurement. |
| 1 | Use RS TYPE#2 | CE level selection for random |
| | | access shall be based on RS |
| | | Type#2 based measurement. |
| 2 | Use RS TYPE#1 OR | CE level selection for random |
| | Use RS TYPE#2 | access shall be based on RS |
| | | Type#1 or RS Type#2 based |
| | | measurement. |
| 3 | Use RS TYPE#1 AND | CE level selection for random |
| | Use RS TYPE#2 | access shall be based on RS |
| | | Type#1 and RS Type#2 based |
| | | measurement. |

In some further embodiments, the UE can be further configured (in addition to the number of configured CE levels) to use a particular type of RS for doing RA to cent based on the type of the procedure, for example based on the importance or criticality of the procedure. For example RS2 (which gives more accurate measurement results) is used for RA for cell change procedure while RS1 is used for RA for initial access to cell1. This is because cell change (e.g. handover) is more critical compared to the initial access, and handover failure should be minimized.

Thus, at step 202, in response to a request for a random access in said cell, and based on information relating to at least one type of reference signal, the wireless device selects at least one type of reference signal.

At step 204, the wireless device performs a measurement in the cell using the selected type or types of reference signal.

Then, in step 206, based on a result of the measurement, the wireless device selects a coverage enhancement level.

Finally, in step 208, the wireless device sends a random access message to the cell using radio resources associated with the selected coverage enhancement level.

Thus, to summarize, the wireless device uses the determined RS type(s) for accessing cent for example, by determining a CE level based on a measurement performed on the determined RS type, and using the measurement results for transmitting the RA message in cell1.

Thus, the UE uses the determined RS type(s) (that is, RS1 or RS2 or both RS1 and RS2) for accessing cell1, for example for transmitting the RA message to cell1. The type of RS to use for accessing cell1 implies performing a CE level selection in the random access procedure. The UE then further selects RA transmission parameters (e.g. radio resources) associated with the selected CE level. The association between the RA transmission parameters and the selected CE level is signalled to the UE, for example in system information.

More specifically in the first step in random access procedure, preamble transmission, the UE selects a preamble based on the selected CE level which in turn is determined in step 206 based on the reference signal measurement on cell1 performed in step 204. This measurement is typically a path-loss measurement, which in turn is based on or is derived from signal strength measurement such as RSRP, NRSRP etc. The UE performs this measurement based on the type of the RS(s) obtained by the UE in step 202. This measurement is used by the UE to determine the coverage enhancement level based on a certain configured measurement criterion. The criterion is typically specified and broadcasted in SIB. In one example, the measurement values used to refer to the different CE levels are signalled using rsrp-ThresholdsPrachInfoList as shown below:

rsrp-ThresholdsPrachInfoList

The criterion for Bandwidth reduced Low complexity (BL) UEs and UEs in CE to select PRACH resource set. Up to 3 RSRP threshold values are signalled to determine the CE level for PRACH, see 3GPP TS 36.213. The first element corresponds to RSRP threshold 1, the second element corresponds to RSRP threshold 2 and so on, see 3GPP TS 36.321. The UE shall ignore this field if only one CE level, i.e. CE level 0, is configured in prach-ParametersListCE. The number of RSRP thresholds present in rsrp-ThresholdsPrachInfoList is equal to the number of CE levels configured in prach-ParametersListCE minus one.

A UE that supports powerClass-14 dBm shall correct the RSRP threshold values before applying them as follows:

RSRP threshold=Signalled RSRP threshold−min{0, (14-min(23, P-Max))} where P-Max is the value of p-Max field.

Based on these thresholds, the UE selects a CE level in step 206. The probability of selecting the correct CE level increases with the improvement in the measurement accuracy. A UE with accurate measurement (e.g. RSRP) can select the CE level with higher reliability than a UE with less accurate measurement. The measurement is considered more accurate if its measurement error with respect to the ideal measurement value is smaller compared to the measurement error associated with the less accurate measurement. Therefore measurement characteristics are important and can affect the CE level selection process. Selecting an incorrect or less accurate CE level can affect both network and UE performance.

One example assumes that the UE selects CE level 1 instead of CE level 0, wherein CE level 1 is extended coverage compared to CE level 0, as described above. The network node may have to transmit signals and channels using more resources for UEs which have selected CE level 1 compared to CE level 0. In practice, this may imply the network node NW1 transmitting signals and channels using repetitions (or a higher number of repetitions) in the time-domain, and in some cases repetitions may also take place over the frequency domain for UEs operating in CE level 1 compared to UEs in CE level 0. This is certainly more expensive for the network node in terms of radio resource, but it may also impact the UE which has to keep its receiver active for a longer time to receive all the control channels and signals using the repetitions. This can certainly affect the power consumption of the UE. Therefore, reliable CE level selection is desirable for both network node and UE.

The differences in physical design of RS types may lead to different measurement performances. For example, RS2 can contain more radio resources containing the actual reference signal compared to RS1, which can result in improved measurement performance, i.e. improved measurement accuracy, improved measurement period, improved measurement processing in UE, etc. An RS2 based measurement may therefore result in a more accurate CE level being selected compared to RS1.

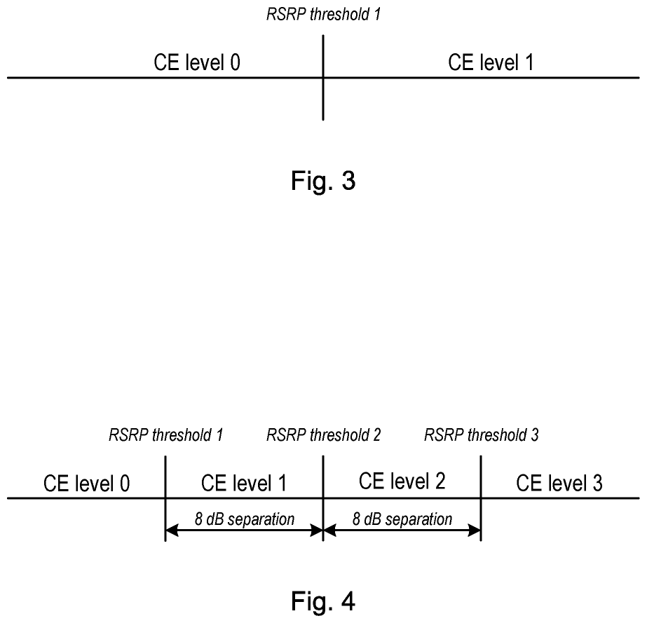

FIG. 3 is a first example, showing CE level selection between two CE levels. In

FIG. 3 there is only one threshold, identified for example as RSRP threshold 1. Therefore, the UE compares the measured value to the threshold, and decides whether to perform random access on CE level 0 or CE level 1.

Thus, if the measured RSRP is below RSRP threshold 1, the UE decides to perform random access on CE level 0, but if the measured RSRP is above RSRP threshold 1, the UE decides to perform random access on CE level 1.

FIG. 4 is a second example, showing CE level selection between four CE levels, namely CE level 0, CE level 1, CE level 2 and CE level 3, again based on RSRP measurement. Thus, in this case, there are three thresholds, identified for example as RSRP threshold 1, RSRP threshold 2, and RSRP threshold 3. RSRP threshold 2 is separated by 8 dB from RSRP threshold 1 and RSRP threshold 3.

Thus, if the measured RSRP is below RSRP threshold 1, the UE decides to perform random access on CE level 0; if the measured RSRP is between RSRP threshold 1 and RSRP threshold 2, the UE decides to perform random access on CE level 1; if the measured RSRP is between RSRP threshold 2 and RSRP threshold 3, the UE decides to perform random access on CE level 2; and, if the measured RSRP is above RSRP threshold 3, the UE decides to perform random access on CE level 3.

This is more challenging than the situation illustrated in FIG. 4, as the UE has to differentiate between 4 RSRP regions using the same measurement which includes a bias of +/−X dB. It is therefore particularly desirable to be able to make a measurement with high accuracy in the situation illustrated in FIG. 4.

Therefore, for example, the UE can be configured to perform measurements based on RS2 in the situation shown in FIG. 4, but can be configured to perform measurements based on RS1 in the situation shown in FIG. 3.

The procedures that are used are adapted to take account of the fact that the reference signals that are used for measurements are different, based on the obtained information. This difference in RS type can lead to different measurement characteristics and/or performances, and may result in different coverage levels e.g. path loss. For example, RS1 based measurements may require a certain sampling rate, measurement period, measurement averaging technique and one set of performance requirements, which together may lead to one CE level, e.g. CE0. RS2 based measurements, on the other hand, may have different characteristics and performance requirements which may lead to a different CE level, e.g. CE1. Examples of requirements are the measurement time (also referred to as the measurement period or L1 measurement period), the measurement accuracy, the signal level or quality down to which requirements apply etc. The measurement accuracy may be an absolute accuracy or a relative accuracy.

For example, RS2 based absolute measurement accuracy may be Y1 dB better than that of the RS1 based measurement accuracy. In another example the RS2 based relative measurement accuracy may be Y2 dB better than that of the RS1 based relative measurement accuracy. Examples of Y1 and Y2 are 2 dB and 3 dB respectively.

The radio resources to be used for RA are associated with CE levels. The UE may obtain the association or mapping between the radio resources and the CE levels based on one or more of the following:
Pre-defined relation or mapping,
Information received from another node e.g. information signalled by the network node to the UE,
Historical data or statistics,
Recently used radio resources for the given CE level of the UE with respect to cell1.

Examples of radio resources are:
Preamble identifier e.g. RA sequence,
Number of repetitions per RA attempt (Rp),
Maximum number of RA attempts (Rr)
UE transmit power level(s) for sending the RA to cell1
Etc.

As an example, the values of Rp and/or Rr may be different for different CE levels. For example Rp is larger for a larger CE level while smaller for a smaller CE level. As an example, if the UE determines CE level 2 then the value of Rp=128. But if the UE determines CE level 1 then the value of Rp=16.

In another example, the UE transmit power required to transmit RA may be larger for larger values of CE level e.g. 20 dBm and 16 dBm for CE level 2 and CE level 1 respectively.

In step 208 of the method shown in FIG. 2, the UE uses the determined or derived radio resources, based on the CE level selected in step 206, to transmit the RA message to cell1.

In some embodiments, the UE may indicate which RS type it used for the measurement for accessing cell1, in the situation where the selection between RS1 and RS2 is carried out by the UE autonomously. The indication may comprise information related to one-time usage of RS1 and/or RS2 for accessing cell1 or it may comprise statistics related to their usage at multiple occasions e.g. several RA transmissions in cell1 over a certain time etc. The indication may further comprise information related to the type of procedure(s) used for accessing cell1 e.g. cell selection, handover etc. The indication could be sent by the UE to the network node using Layer 1 channels such as the Physical Uplink Control Channel (PUCCH), Medium Access Control (MAC), or even RRC. The network node may use the received information for one or more tasks. Examples of such tasks are: modifying or adapting the number of CE levels to be configured in cell1; adapting receiver parameters of the BS receiving signals from the UE in cell1; configuring the UE with a particular RS type to be used by the UE for accessing cell1 etc. For example, the network node may configure the UE with RS2 if the received indications reveal that the UE has used RS2 for accessing cell1 at least X % of the time (e.g. X=60).

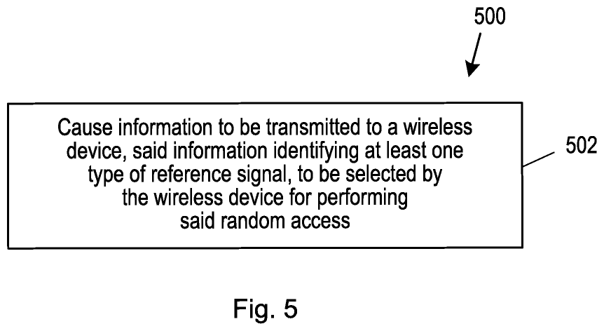

FIG. 5 is a flow chart, showing a method 500 performed by a network node in accordance with particular embodiments for configuring a wireless device for performing a random access in a cell.

The method 500 comprises step 502 of causing information to be transmitted to a wireless device, where the information identifies at least one type of reference signal, to be selected by the wireless device for performing said random access.

The network node may decide the selection between different RS to be used by the wireless device based upon one or more criteria.

One such criterion is a ratio of ACK/NACK. That is, the NW may first enable RS1 for a certain duration and then enable RS2 and compare the performance. The NW may also enable a combination of RS1 and RS2. ACK/NACK here could simply be a number of repetitions that is selected such that the UE is able to successfully decode the message and send a response to the NW. Data analytics (for example, machine learning) could be used for determining the applicability of each RS type or manual post processing could be done to compare the results of different RS types.

Another criterion is the ratio of Transmission power RS1/Transmission Power RS2. This may also consider the subframes and periodicity needed.

Another criterion is the duration of RS2, such that if RS2 is configured to be longer it may be used for higher CE levels.

Another criterion is the needed granularity in Coverage Level, for example the number of CE levels configured or expected to be configured in cell1 for enabling the UE to access cell1.

Another criterion is the relevant RAN procedure. For example, during Random access the network may select RS Type X1 and for Mobility/Handover the network may select RS type X2. Similarly, for cell selection the network may select type X1 and for cell reselection the network may select X2.

In some cases, the NW may select a RS type based upon certain criteria relating to the UE. For example, UEs that use the e-drx cycle can only use RS type X. The selection could also be based upon battery indication as shown below, and could then instruct the UE to perform the measurements based upon a certain RS type X. The selection could also be conveyed using a dedicated signalling such as RRCConnectionRelease.

From 3GPP 23.682 Version f50. Section 5.10.1

TABLE 5.10.1-1
CP parameters

| | |
|---|---|
| Battery | Identifies power consumption criticality for the UE: if the UE |
| indication | is battery powered with not rechargeable/not replaceable |
| | battery, battery powered with rechargeable/replaceable |
| | battery, or not battery powered. [optional] |

After selecting the RS type based on one or more criteria as described above, the NW configures the UE with the information related to the selected RS type for enabling the UE to access cell1. The NW may also indicate to the UE the type of procedure(s) (e.g. RA for HO) for which the indicated RS type is applicable. The signalled information may comprise explicit information about the RS type or a parameter related to threshold number of CE levels (N_{G}) as described above, that is used by the UE in selecting the RS type.

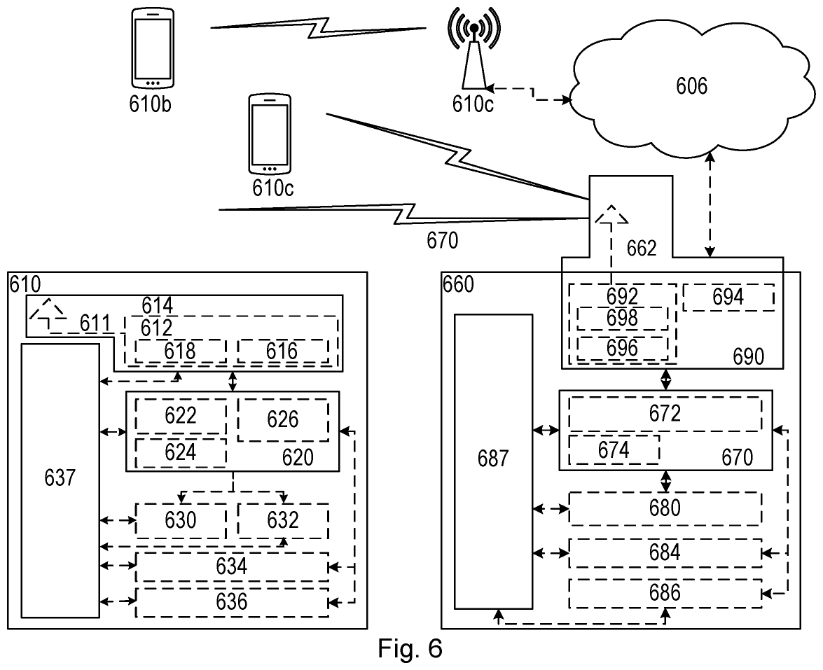

FIG. 6 shows a wireless network in accordance with some embodiments. Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system.

In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

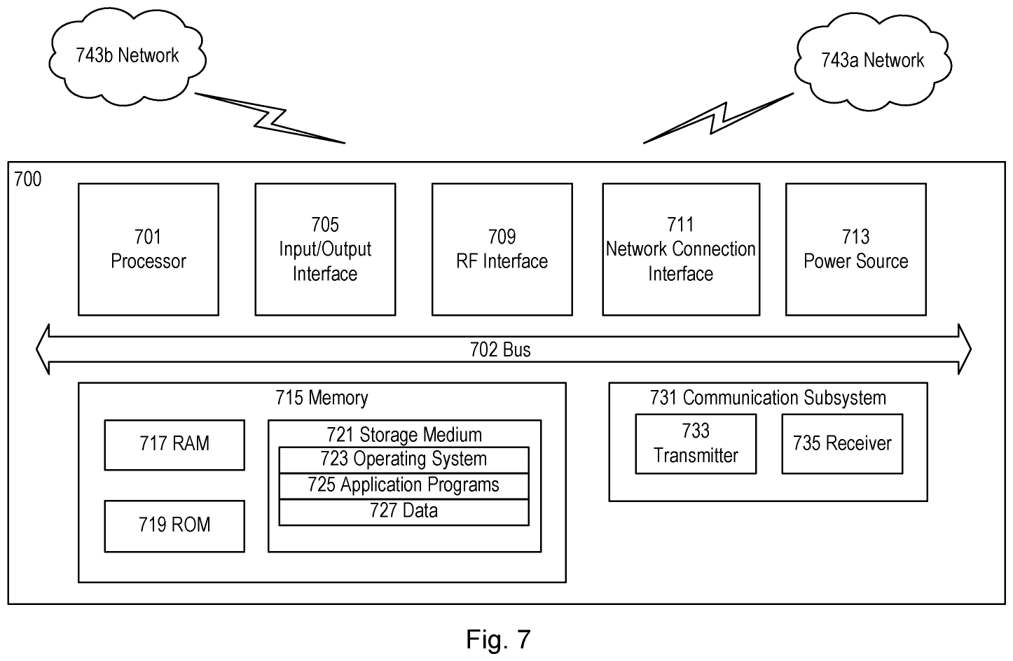

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

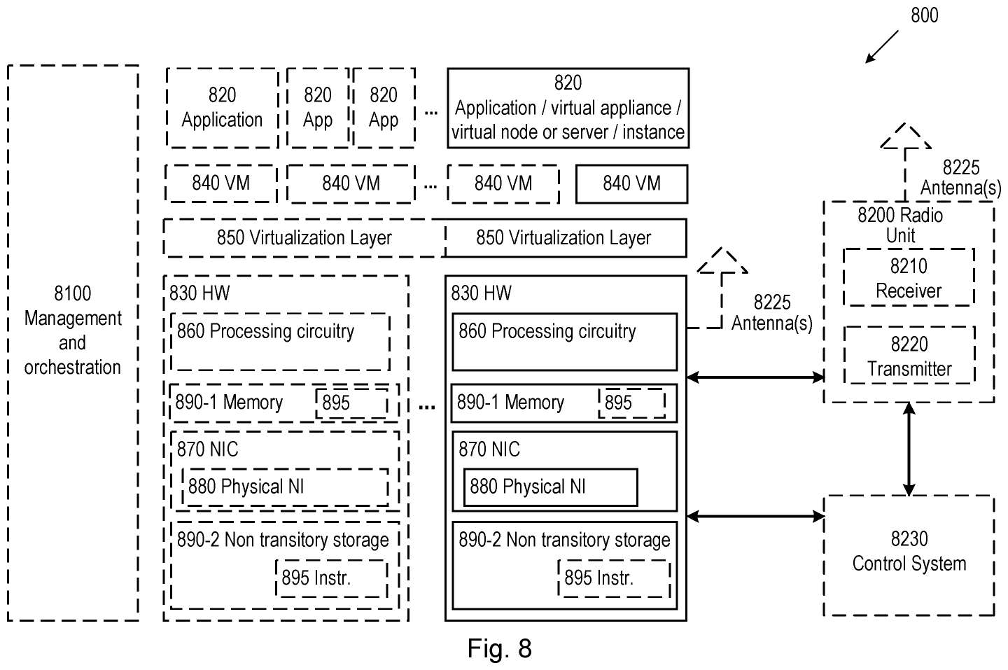

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

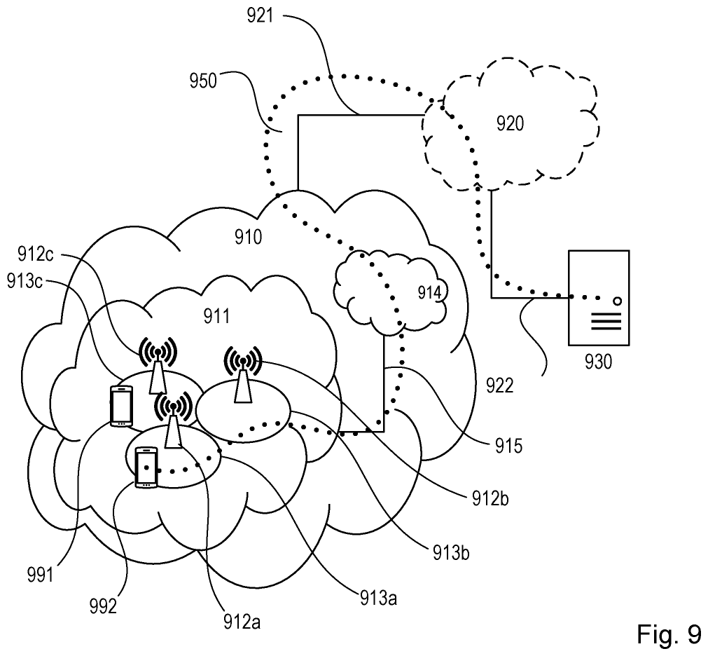

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

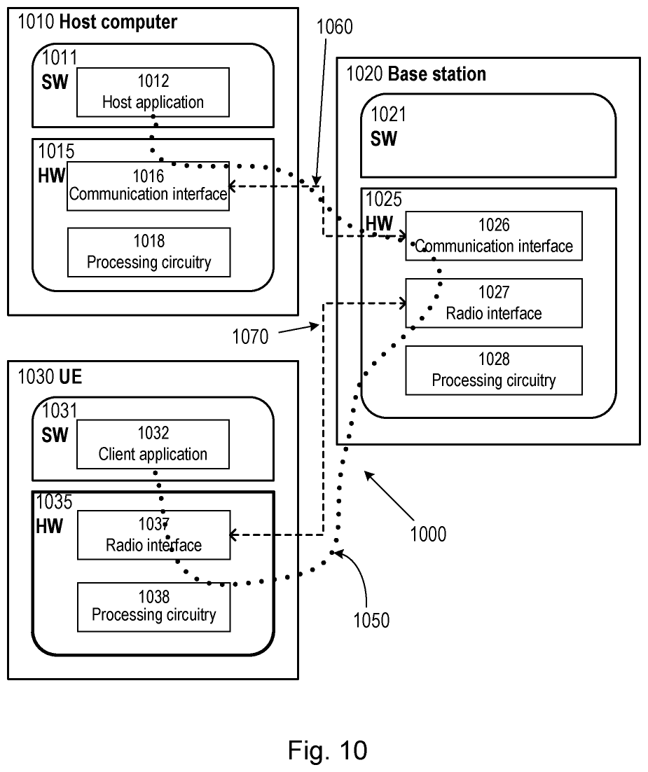

FIG. 10 shows a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network). Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve the data rate, latency, and/or power consumption, and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

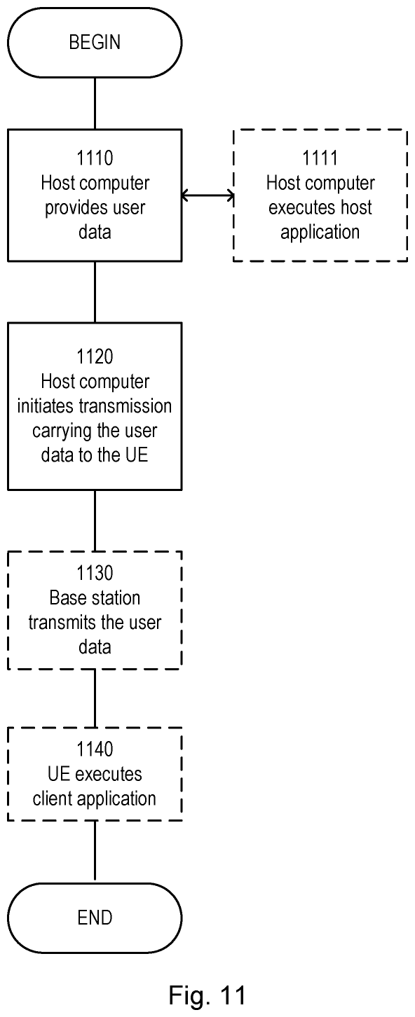

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

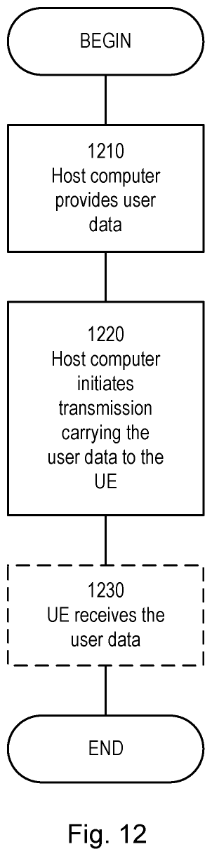

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

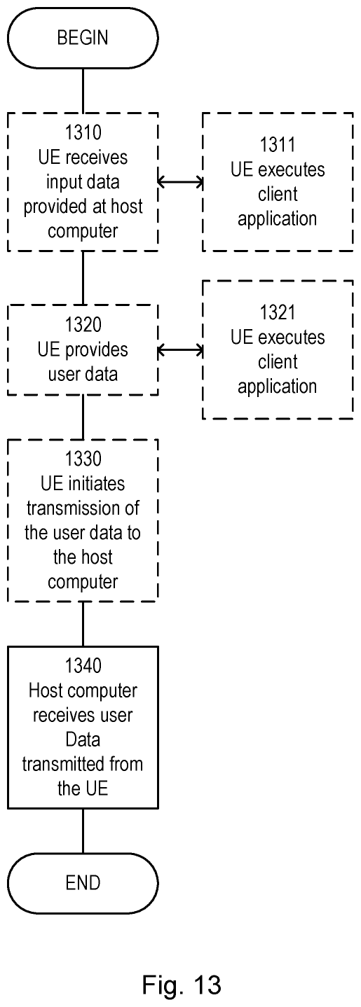

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

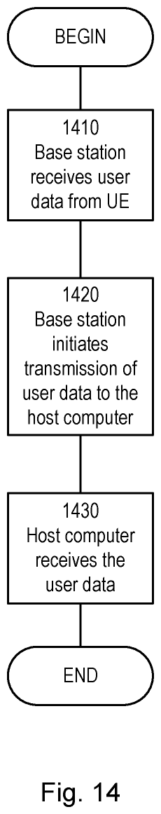

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

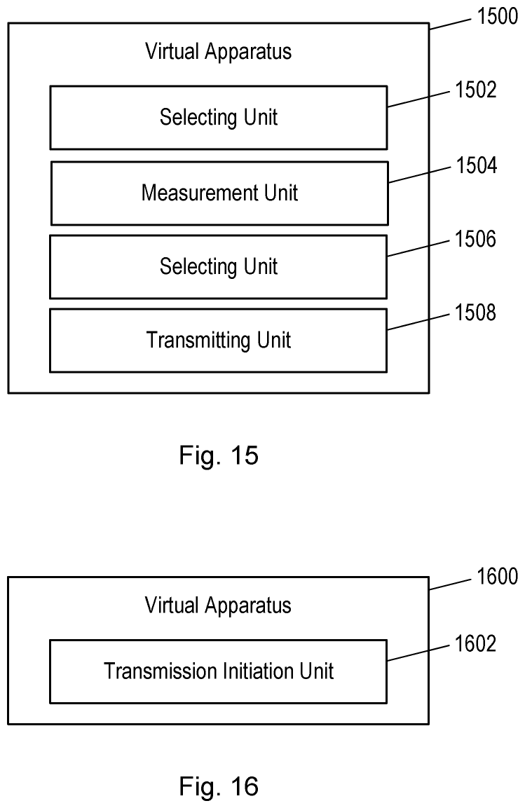

FIG. 15 illustrates a schematic block diagram of an apparatus 1500 in a wireless network (for example, the wireless network shown in FIG. 6). The apparatus may be implemented in a wireless device or network node (e.g., wireless device 610 or network node 660 shown in FIG. 6). Apparatus 1500 is operable to carry out the example method described with reference to FIG. 2 and possibly any other processes or methods disclosed herein. It is also to be understood that the method of FIG. 2 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause selecting unit 1502, measurement unit 1504, selecting unit 1506, and transmitting unit 1508, and any other suitable units of apparatus 1500 to perform corresponding functions according one or more embodiments of the present disclosure.

As illustrated in FIG. 15, apparatus 1500 includes selecting unit 1502, measurement unit 1504, selecting unit 1506, and transmitting unit 1508. The selecting unit 1502 is configured, in response to a request for a random access in said cell, and based on information relating to at least one type of reference signal, to select at least one type of reference signal. The measurement unit 1504 is configured to perform a measurement in said cell using the selected at least one type of reference signal. The selecting unit 1506 is configured, based on a result of the measurement, to select a coverage enhancement level. The transmitting unit 1508 is configured to send a random access message to said cell using radio resources associated with the selected coverage enhancement level.

FIG. 16 illustrates a schematic block diagram of an apparatus 1600 in a wireless network (for example, the wireless network shown in FIG. 6). The apparatus may be implemented in a wireless device or network node (e.g., wireless device 610 or network node 660 shown in FIG. 6). Apparatus 1600 is operable to carry out the example method described with reference to FIG. 5 and possibly any other processes or methods disclosed herein. It is also to be understood that the method of FIG. 5 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmission initiation unit 1602, and any other suitable units of apparatus 1600 to perform corresponding functions according one or more embodiments of the present disclosure.

As illustrated in FIG. 16, apparatus 1600 includes transmission initiation unit 1602, which allows a wireless device to be configured for performing a random access in a cell by causing information to be transmitted to a wireless device, said information identifying at least one type of reference signal, to be selected by the wireless device for performing said random access.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the
band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1.-30. (canceled)

31. A method performed by a wireless device for accessing a cell of a network, the method comprising:
in response to a request for a random access in said cell, and based on information relating to at least one type of reference signal associated with at least a number of coverage enhancement levels configured in said cell, selecting at least one type of reference signal;
performing a measurement in said cell using the selected at least one type of reference signal;
based on a result of the measurement, selecting a coverage enhancement level; and
sending a random access message to said cell using radio resources associated with the selected coverage enhancement level.

32. The method of claim 31, further comprising receiving the information relating to at least one type of reference signal from a Radio Resource Control (RRC) System Information Broadcast message, or in dedicated RRC signalling.

33. The method of claim 31, wherein selecting the at least one type of reference signal comprises:
selecting a first type of reference signal responsive to the number of coverage enhancement levels configured in said cell not exceeding a threshold number; or
selecting a second type of reference signal responsive to the number of coverage enhancement levels configured in said cell exceeding said threshold number.

34. The method of claim 33, wherein the first type of reference signal is a Cell-Specific Reference Signal (CRS) or a Narrowband Reference Signal (NRS), and the second type of reference signal is a Resynchronization signal (RSS), a Secondary Synchronization Signal (SSS) or a Narrowband Secondary Synchronization Signal (NSSS).

35. The method of claim 33, wherein the threshold number is a predefined number.

36. The method of claim 33, further comprising receiving information from the network determining the threshold number.

37. The method of claim 33, further comprising determining the threshold number based on information stored in the wireless device.

38. The method of claim 37, further comprising determining the threshold number based on stored information relating to previous usage of the wireless device.

39. The method of claim 33, further comprising selecting the at least one type of reference signal based on information signalled to the wireless device from the network.

40. The method of claim 39, wherein the second type of reference signal is a Resynchronization signal (RSS).

41. The method of claim 33, further comprising selecting the at least one type of reference signal based on a procedure requiring said random access.

42. The method of claim 41, further comprising:
selecting a first type of reference signal for at least a first procedure; and
selecting a second type of reference signal for at least a second procedure.

43. The method of claim 41, comprising:
selecting a first type of reference signal for an initial access procedure requiring said random access; and
selecting a second type of reference signal for a cell change procedure requiring said random access.

44. The method of claim 31, wherein the measurement comprises a path loss measurement or a signal strength measurement.

45. The method of claim 31, further comprising selecting the coverage enhancement level based on a result of comparing the result of the measurement with at least one threshold value.

46. A method performed by a network node for configuring a wireless device for performing a random access in a cell, the method comprising:
causing information to be transmitted to the wireless device, said information identifying at least one type of reference signal, to be selected by the wireless device for performing a measurement, wherein the wireless device uses a result of the measurement to select resources to be used for said random access; and
selecting the at least one type of reference signal to be identified to the wireless device based on a number of coverage enhancement levels configured or expected to be configured for enabling the wireless device to access said cell.

47. The method of claim 46, further comprising selecting the at least one type of reference signal to be identified to the wireless device based on a procedure for which the wireless device requires to access said cell.

48. The method of claim 47, further comprising:
selecting a first type of reference signal to be identified to the wireless device for an initial random access; and
selecting a second type of reference signal to be identified to the wireless device for a cell change procedure.

49. The method of claim 48, wherein the first type of reference signal is a Cell-Specific Reference Signal (CRS) or a Narrowband Reference Signal (NRS), and the second type of reference signal is a Resynchronization signal (RSS) or a Secondary Synchronization Signal (SSS) or a Narrowband Secondary Synchronization Signal (NSSS).

50. The method of claim 46, further comprising:
receiving information from the wireless device about a selected type of reference signal; and
using said received information for one or more of:
modifying or adapting a number of coverage enhancement levels to be configured in said cell,
adapting receiver parameters of a base station for receiving signals from the wireless device, and
configuring the wireless device with a particular type of reference signal to be used by the wireless device for accessing said cell.

51. A wireless device for accessing a cell of a network, the wireless device comprising:
at least one processor; and
a memory storing instructions that, when executed by the at least one processor, cause the wireless device to:
in response to a request for a random access in said cell, and based on information relating to at least one type of reference signal associated with at least a number of coverage enhancement levels configured in said cell, select at least one type of reference signal;
perform a measurement in said cell using the selected at least one type of reference signal;
based on a result of the measurement, select a coverage enhancement level; and
send a random access message to said cell using radio resources associated with the selected coverage enhancement level.

52. A network node for configuring a wireless device for performing a random access in a cell, the network node comprising:
at least one processor; and
a memory storing instructions that, when executed by the at least one processor, cause the network node to:
cause information to be transmitted to the wireless device, said information identifying at least one type of reference signal, to be selected by the wireless device for performing a measurement, wherein the wireless device is configured to use a result of the measurement to select resources to be used for said random access; and
select the at least one type of reference signal to be identified to the wireless device based on a number of coverage enhancement levels configured or expected to be configured for enabling the wireless device to access said cell.
